(19) United States
(12) Patent Application Publication
(10) Pub. No.: US 2012/0242502 A1
(43) Pub. Date: Sep. 27, 2012

(54) Wheel Unit, Central Unit and System for Localizing a Plurality of Wheels on a Vehicle

(75) Inventors: Christoph Steiner, Markt Hartmannsdorf (AT); Jakob Jongsma, Graz (AT)

(73) Assignee: Infineon Technologies AG, Neubiberg (DE)

(21) Appl. No.: 13/072,392

(22) Filed: Mar. 25, 2011

(51) Int. Cl. H04Q 9/00

(52) U.S. Cl. 340/870.07

(57) ABSTRACT

Embodiments of the present invention provide a wheel unit configured to transmit a transmit signal at a predefined rotational position of a wheel rotating around a rotational axis, when the wheel unit is attached to the wheel.

### TECHNICAL FIELD

Embodiments of the present invention relate to a wheel unit.

Further embodiments of the present invention relate to a central unit for localizing a wheel on a vehicle. Some embodiments of the present invention relate to a system for localizing a plurality of wheels on a vehicle. Moreover, some embodiments of the present invention relate to a low cost and robust method for wheel localization.

### BACKGROUND

In order to determine a location of a wheel on a vehicle a wheel unit can be attached to the wheel. For example, if the vehicle comprises four wheels then the possible locations of the wheel on the vehicle are front-left, front-right, rear-left and rear-right.

### SUMMARY OF THE INVENTION

Embodiments of the present invention provide a wheel unit configured to transmit a transmit signal at a predefined rotational position of a wheel rotating around a rotational axis, when the wheel unit is attached to the wheel.

Embodiments of the present invention provide a central unit for localizing a wheel on a vehicle. The central unit comprises a memory having stored thereon a plurality of reference information, the plurality of reference information corresponding to locations of the wheel on the vehicle. Furthermore, the central unit is configured to receive a receive signal based on a transmit signal transmitted by a wheel unit over a communication channel between the wheel unit and the central unit at a predefined rotational position of the wheel, the wheel unit is attached to. Moreover, the central unit is configured to derive an information from the receive signal and to localize the wheel on the vehicle based on a comparison between the plurality of reference information and the information.

Further embodiments of the present invention relate to a system for localizing a plurality of wheels on a vehicle. The system comprises a central unit, a first wheel unit and a second wheel unit. The central unit comprises a memory having stored thereon a plurality of reference information, the plurality of reference information corresponding to locations of the plurality of wheels on the vehicle. The first wheel unit is attached to a first wheel of the plurality of wheels and configured to transmit a first transmit signal at a predefined rotational position of the first wheel. The second wheel unit is attached to a second wheel of the plurality of wheels and configured to transmit a second transmit signal at the predefined rotational position of the second wheel. Furthermore, the central unit is configured to receive a first receive signal based on the first transmit signal transmitted by the first wheel unit over a communication channel between the first wheel unit and the central unit, and to receive a second receive signal based on the second transmit signal transmitted by the second wheel unit over a communication channel between the second wheel unit and the central unit. Moreover, the central unit is further configured to derive a first information from the first receive signal and a second information from the second receive signal. The first wheel is localized on the vehicle based on a comparison between the plurality of reference information and the first information. The second wheel is localized on the vehicle based on a comparison between the plurality of reference information and the second information.

### BRIEF DESCRIPTION OF THE DRAWINGS

Embodiments of the present invention are described herein making reference to the appended drawings.

FIG. 1a shows a block diagram of a wheel unit according to an embodiment of the present invention;

FIG. 1b shows a block diagram of a central unit for localizing a wheel on a vehicle according to an embodiment of the present invention;

FIG. 1c shows a schematic view of a system for localizing a plurality of wheels on a vehicle according to an embodiment of the present invention;

FIG. 2 shows a sectional view of a wheel with a wheel unit attached to the wheel according to an embodiment of the present invention;

FIG. 3 shows a perspective view and a top view of a vehicle with four wheels and an apparatus for determining a location of each of the four wheels on the vehicle according to an embodiment of the present invention;

FIG. 4 shows an exemplarily diagram of a first RSS curve derived from a first receive signal pattern and a second RSS curve derived from a second receive signal pattern for a full rotation of a first and second wheel;

FIG. 5 shows a diagram of an average probability of a localization error as a function of the signal-to-noise ratio when the information derived from the receive signal is an RSS value;

FIG. 6 shows a flowchart of a method for providing a plurality of reference information for a system for localizing a plurality of wheels on a vehicle as already described in detail above; and

FIG. 7 shows a flowchart of a method for localizing a plurality of wheels on a vehicle.

Before discussing the present invention in further detail using the drawings, it is pointed out that in the figures identical elements and elements having the same functionality or the same effect are provided with same reference numbers so that the description of these elements and the functionality thereof illustrated in the different embodiments is mutually exchangeable or may be applied to one another in the different embodiments.

### DETAILED DESCRIPTION OF ILLUSTRATIVE EMBODIMENTS

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

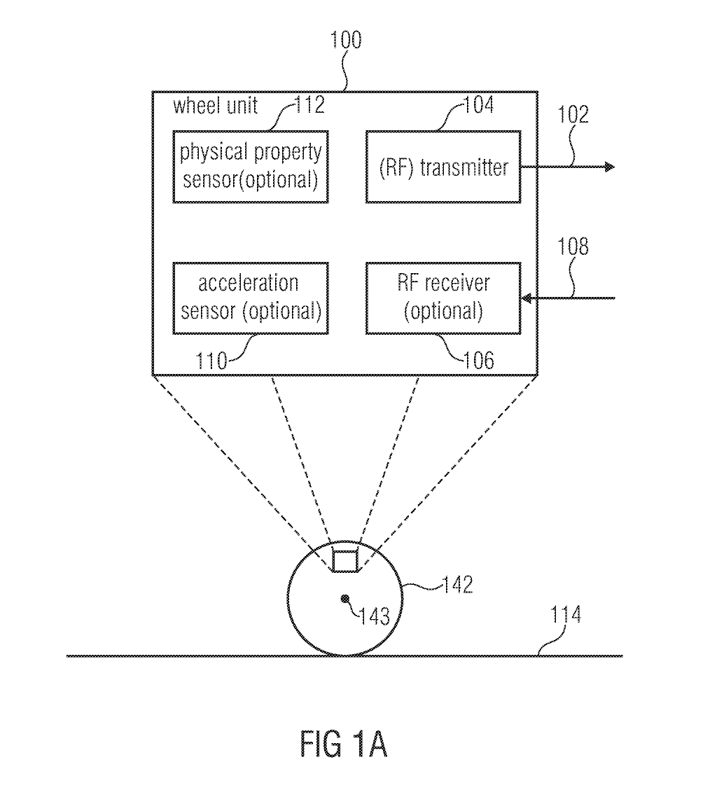

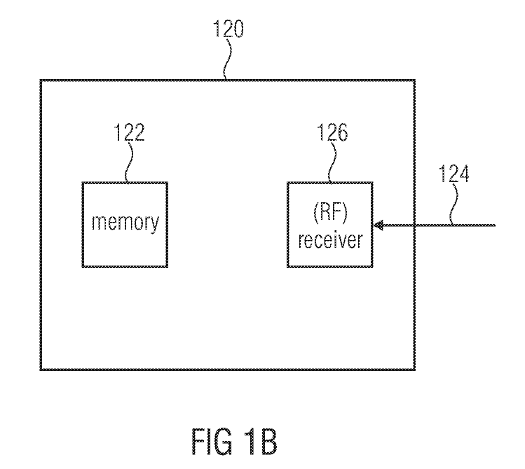

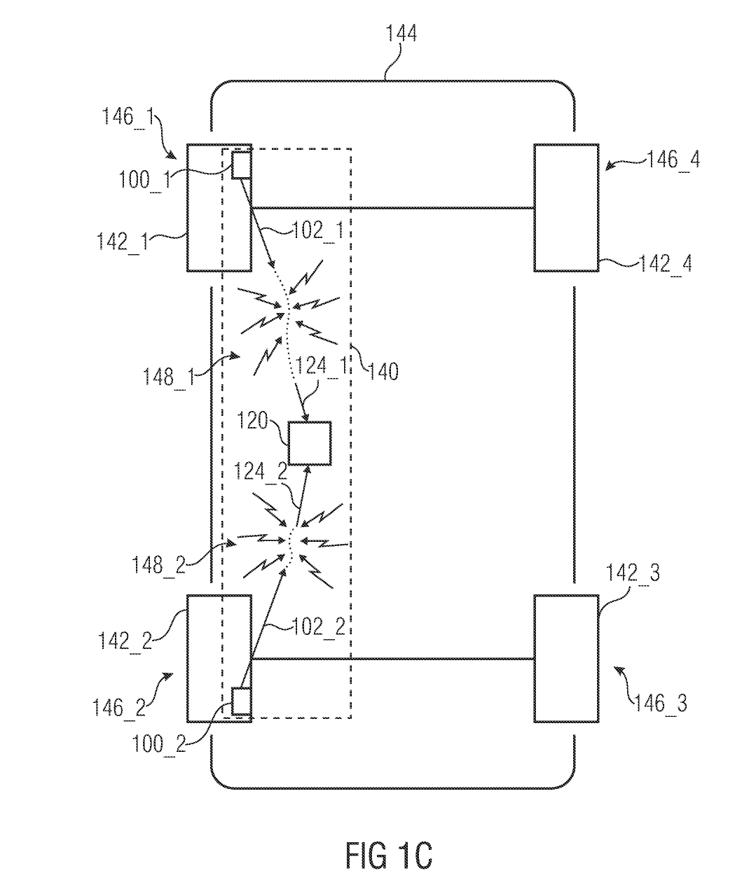

FIG. 1a shows a block diagram of a wheel unit 100 according to an embodiment of the present invention. The wheel unit 100 is configured to transmit a transmit signal 102 at a predefined rotational position of a wheel 142 rotating around a rotational axis 143, when the wheel unit 100 is attached to the wheel 142.

FIG. 1b shows a block diagram of a central unit 120 for localizing a wheel 142 on a vehicle according to an embodiment of the present invention. The central unit 120 comprises a memory 122 having stored thereon a plurality of reference information, the plurality of reference information corresponding to locations of the wheel 142 on the vehicle. Furthermore, the central unit 120 is configured to receive a receive signal 124 based on a transmit signal 102 transmitted by a wheel unit 100 over a communication channel or signal propagation paths between the wheel unit 100 and the central unit 120 at a predefined rotational position of the wheel 142, the wheel unit 100 is attached to. Moreover, the central unit 120 is configured to derive an information from the receive signal 124 and to localize the wheel 142 on the vehicle based on a comparison between the plurality of reference information and the information.

In some embodiments, the wheel unit 100 is configured to transmit the transmit signal 102 at the predefined rotational position of the wheel 142. In other words, as the wheel 142 rotates around its axis 143, the wheel unit 100 transmits the transmit signal 102 only at the predefined rotational position of the wheel 142.

Furthermore, in some embodiments, the central unit 120 is configured to receive the receive signal 124 based on the transmit signal 102 transmitted by the wheel unit 100 over the communication channel between the wheel unit 100 and the central unit 120. The transmit signal 102 is modified during the transmission over the communication channel or propagation paths between the wheel unit 100 and the central unit 120, for example, due to reflection, diffraction, and multipath propagation within the vehicle. In addition, type and/or degree of modification of the transmit signal 102 is a function of the location of the wheel 142 on the vehicle 144, for example, due to differences and/or asymmetries in the structure of the vehicle. Hence, the central unit 120 is able to determine the location of the wheel 142 on the vehicle by deriving an information from the receive signal 124 and comparing the plurality of reference information with the information derived from the receive signal 124.

In the following, the predefined rotational position of the wheel 142 is also referred to as predefined rotation angle or transmission angle α* since the predefined rotational position of the wheel 142 defines the rotation angle α* of the wheel 142 at which the wheel unit 100 transmits the transmit signal 102.

According to the concept of the present invention, a power consumption of the wheel unit 100 required for localization is reduced or even minimized by using only one predefined rotation angle α*, e.g., by transmitting only one data packet. In other words, a power consumption of the wheel unit 100 required for localization is reduced or even minimized by transmitting the transmit signal 102, e.g., one data packet, only once at the predefined rotational position of the wheel 142 per full rotation of the wheel 142. In some embodiments, the wheel unit 100 can be configured to sense a physical property, e.g., temperature or pressure, of the wheel 142 in order to obtain a sensed information. In this case, the transmit signal 102, e.g., the one data packet, has to be transmitted anyway in order to deliver the sensed information to the central unit 120.

Furthermore, since the transmission angle α* is predetermined and/or fixed, no synchronization or timing circuits are required within the central unit 120 (receiver). Additionally, a dependency of the receive signal 124 (e.g., information of a signal pattern) on the vehicle's velocity is removed. Moreover, a localization performance can be increased or even optimized by a suitable choice of the transmission angle α*.

FIG. 1c shows a schematic view of a system 140 for localizing a plurality of wheels 142_1 to 142_n (n=4) on a vehicle 144 according to an embodiment of the present invention. The system comprises a central unit 120, a first wheel unit 100_1 and a second wheel unit 100_2. The central unit 120 comprises a memory 122 having stored thereon a plurality of reference information, the plurality of reference information corresponding to locations 146_1 to 146_n (n=4) of the plurality of wheels 142_1 to 142_n (n=4) on the vehicle.

The first wheel unit 100_1 is attached to a first wheel 142_1 of the plurality of wheels 142_1 to 142_n (n=4) and configured to transmit a first transmit signal 102_1 at a predefined rotational position of the first wheel 142_1. The second wheel unit 100_2 is attached to a second wheel 142_2 of the plurality of wheels 142_1 to 142_n (n=4) and configured to transmit a second transmit signal 102_2 at the predefined rotational position of the second wheel 142_2.

Furthermore, the central unit 120 is configured to receive a first receive signal 124_1 based on the first transmit signal 102_1 transmitted by the first wheel unit 100_1 over a communication channel 148_1 between the first wheel unit 100_1 and the central unit 120, and to receive a second receive signal 124_2 based on the second transmit signal 102_2 transmitted by the second wheel unit 100_2 over a communication channel 148_2 between the second wheel unit 100_2 and the central unit 120.

Moreover, the central unit 120 is further configured to derive a first information from the first receive signal 124_1 and a second information from the second receive signal 124_2, and to localize the first wheel 142_1 on the vehicle 144 based on a comparison between the plurality of reference information and the first information, and to localize the second wheel 142_2 on the vehicle 144 based on a comparison between the plurality of reference information and the second information.

The vehicle 144 shown in FIG. 1c exemplarily comprises four (n=4) wheels 142_1 to 142_4. Hence, the possible locations of the four wheels 142_1 to 142_4 on the vehicle 144 are rear-left 146_1, front-left 146_2, front-right 146_3 and rear-right 146_4. In general, the system 100 is able to locate a plurality of wheels 142_1 to 142_n on a vehicle 144, wherein n is a natural number greater than or equal to two (n≧2). For example, in some embodiments, the vehicle 144 can be a bike having two wheels (n=2), a car having four wheels and an additional spare wheel (n=5), a truck or bus having six (n=6), eight (n=8) or even more wheels.

In the following, features of the wheel unit 100 shown in FIG. 1a and features of the central unit 120 shown in FIG. 1b are described. Naturally, the features described in the following are also applicable to the system 140 for localizing a plurality of wheels 142_1 to 142_n (n=4) on a vehicle 144 shown in FIG. 1c.

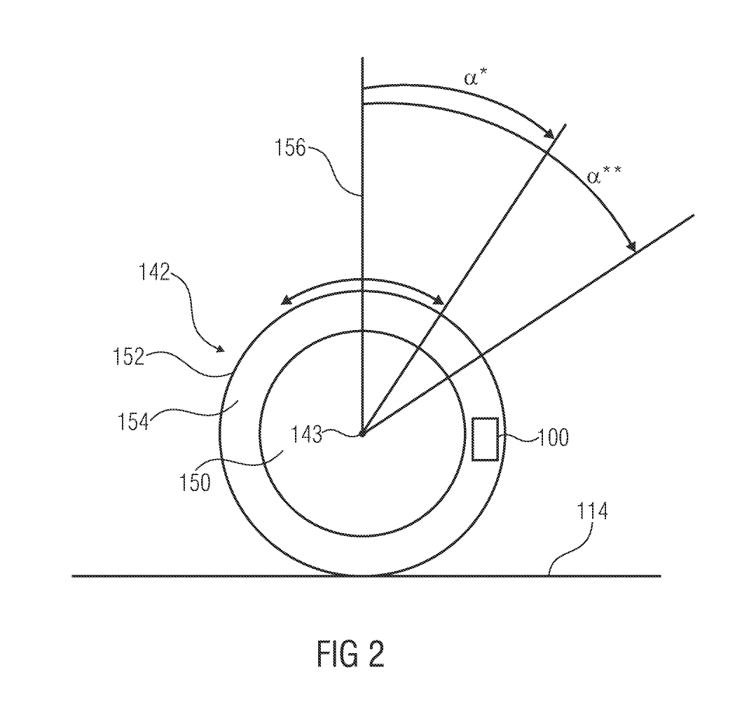

FIG. 2 shows a sectional view of a wheel 142 with a wheel unit 100 attached to the wheel 142 according to an embodiment of the present invention. The wheel 142 comprises a rim 150, a tire 152 and a gas (or mixture of gases) 154 enclosed between the rim 150 and tire 152. The wheel unit 100 can be attached to an inner side of the tire 152 or to the rim 150 in an area adjacent to the inner side of the tire 152, for example, between the edges of the rim 150. Moreover, the wheel unit 100 can be arranged within an area of a valve of the wheel 142.

The wheel unit 100 is configured to transmit the transmit signal 102 at the predefined rotational position of the wheel 142, or in other words, at the predefined rotation angle α* of the wheel 142. As shown in FIG. 2, the rotation angle α* can be measured relative to a reference line 156 that is perpendicular to the axis 143 of the wheel 142. The reference line 156 may point along a predefined direction, for example, in a positive or negative horizontal or vertical direction.

In some embodiments, the wheel unit 100 can be configured to transmit an additional transmit signal at an additional predefined rotational position of the wheel 142. In this case, a plurality of additional reference information can be stored on the memory 122 of the central unit 120, the plurality of additional reference information corresponding to the locations of the plurality of wheels on the vehicle. Moreover, the central unit 120 can be configured to receive an additional receive signal based on the additional transmit signal transmitted by the wheel unit 100 at the additional predefined rotational position of the wheel 142. Furthermore, the central unit 120 can be further configured to derive an additional information from the additional receive signal and to localize the wheel 142 on the vehicle 144 further based on a comparison between the plurality of additional reference information and the additional information.

For example, in a noisy environment with a low SNR (SNR=signal-to-noise ratio), as can be the case in some vehicles, it may be useful to transmit an additional transmit signal at an additional rotational position of the wheel 142 in order to reduce an average probability of a localization error. In other words, the transmit signal 102 can be transmitted at the predefined transmission angle α*, where the additional transmit signal is transmitted at the additional predefined transmission angle α** in order to reduce an average probability of a localization error, the predefined transmission angle α* being different from the additional predefined transmission angle α**. Optionally, m additional predefined rotation angles can be used to further reduce an average probability of a localization error, wherein m is a natural number greater than or equal to one (m≧1). Nevertheless, the power consumption of the wheel unit 100 for localization may increase for each additional predefined transmission angle.

Note that, the transmit signal and the additional transmit signal can be the same. Nevertheless, the propagation channel between the wheel unit 100 and the central unit 120 may be (slightly) different for the transmit signal and the additional transmit signal since the predefined transmission angle α*, e.g., 24°, and the additional predefined transmission angle α**, e.g., 119°, are not the same. Hence, the receive signal and the additional receive signal might be (slightly) different even if the transmit signal and the additional transmit are the same.

In some embodiments, the central unit 120 can be configured to compare the information derived from the receive signal with the plurality of reference information, to compare the additional information derived from the additional receive signal with the plurality of additional reference information, and to evaluate statistically the comparisons in order to locate the wheel 142 on the vehicle 144.

In some embodiments, the wheel unit 100 can comprise an RF transmitter (104 in FIG. 1a) configured to transmit the transmit signal 102. The RF transmitter 104 can be configured to transmit the transmit signal 102 having a predefined carrier frequency or a predefined frequency band with a predefined bandwidth around a centered carrier frequency. Moreover, the RF transmitter 104 can be configured to transmit the transmit signal 102 comprising at least two (carrier) frequencies located in different frequency bands, such as ISM bands (ISM=industrial, scientific and medical).

Naturally, the central unit 120 can comprise an RF receiver (126 in FIG. 1b) configured to receive the receive signal 124. The RF receiver 126 can be configured to receive the receive signal 124 having a predefined carrier frequency or a predefined frequency band with a predefined bandwidth around a centered carrier frequency. Moreover, the RF receiver 126 can be configured to receive the receive signal 124 comprising at least two (carrier) frequencies located at different frequency bands, such as ISM bands.

Note that, the transmit signal 102 comprising the at least two frequencies located in different frequency bands can be referred to as a transmit signal pattern. Moreover, transmitting the transmit signal 102 comprising the at least two frequencies located in different frequency bands over the communication channel between wheel unit 100 and central unit 120 may lead to a receive signal pattern, for example, due to a frequency dependent attenuation of the transmit signal 102 by the communication channel.

The plurality of reference information stored on the memory 122 of the central unit 120 can be RSS reference values (RSS=received signal strength), the RSS reference values corresponding to the locations of the wheel 142 on the vehicle 144. In that case, the central unit 120 can be configured to derive an RSS value from the receive signal and to localize the wheel 142 on the vehicle based on the RSS value. For example, the central unit 120 can be configured to localize the wheel 142 on the vehicle by comparing the RSS value derived from the receive signal with the RSS reference values stored on the memory 122. Thereby, the wheel 142 is most likely located at the location related to the RSS reference value having the smallest difference to the RSS value.

In some embodiments, the RF receiver 126 of the central unit 120 is a linear RF receiver, where the information derived from the receive signal is a characteristic of the channel between wheel unit 100 and central unit 120. Moreover, the central unit 120 can be configured to estimate the channel between wheel unit 100 and central unit 120, where the information derived from the receive signal 124 is a channel coefficient. Furthermore, the RF transmitter 104 of the wheel unit 100 can be configured to use an OFDM scheme (OFDM=orthogonal frequency-division multiplexing) to transmit a broadband transmit signal 102. In this case, the RF receiver 126 of the central unit 120 receives a broadband receive signal 124, where the central unit 120 can be configured to derive a set of channel coefficients for multiple frequencies of the broadband receive signal 124.

In order to reduce the average probability of a localization error, the wheel unit 100 can further comprise an RF receiver (106 in FIG. 1a) configured to receive a receive signal 108 based on a transmit signal transmitted by a further wheel unit over a communication channel between the further wheel unit and the wheel unit at a predefined rotational position of a further wheel, the further wheel unit is attached to. Thereby, the wheel unit 100 can be configured to transmit the transmit signal 102 comprising an attached information based on the receive signal 108 received from the further wheel unit. In that case, the receive signal 124 received by the central unit 120 comprises the attached information, where the central unit 120 can be configured to locate the wheel 142 on the vehicle 144 further based on the attached information. For example, in some embodiments, the wheel unit 100 can be configured to derive an RSS value from the receive signal 108 received from the further wheel unit and to attach the RSS value derived from the receive signal 108 to the transmit signal 102.

Note that the further wheel unit can be configured to transmit the transmit signal at the predefined rotational position of the further wheel, but this does not necessarily implicate that the wheel unit 100 receives the receive signal 108 of the further wheel unit each time at the same rotational position of the wheel 142, the wheel unit 100 is attached to. In fact, the rotational position of wheel 142 at which the wheel unit 100 receives the receive signal 108 from the further wheel unit may change due to different rotational velocities of the wheel 142 and the further wheel, for example, when cornering. The change of the rotational position of the wheel 142 at which the wheel unit 100 receives the receive signal 108 from the further wheel unit may lead to differences in the communication channel between the further wheel unit and the wheel unit 100. Therefore, in some embodiments, the central unit 120 can be configured to localize the wheel 142 on the vehicle 144 further based on a statistical evaluation of the attached information. In some embodiments the wheel unit 100 which receives the receive signal 108 from the further wheel unit can estimate its rotational position at the time of reception in a similar manner as it determines the predefined rotational position for transmission. This additional information supports the localization task of the central unit 120.

In order to transmit the transmit signal 102 at the predefined rotational position of the wheel 142, the wheel unit 100 can comprise an acceleration sensor (110 FIG. 1a), for example, a single-axis accelerometer, configured to provide an acceleration signal. In other words, the wheel unit 100 can comprise an acceleration sensor 110 configured to provide an acceleration signal, wherein the wheel unit 100 is configured to transmit the transmit signal 102 at the predefined rotational position of the wheel 142 based on the acceleration signal.

In some embodiments, the acceleration signal may have the shape of a sine or of a superimposed sine for a full rotation of the wheel 142. In other words, the time duration of a full rotation of the wheel 142 corresponds to one period of the superimposed sine. The wheel unit 100 can be configured to determine the actual rotational position of the wheel 142 based on the acceleration signal and hence the time instant or the time remaining to transmit the transmit signal 102. Furthermore, the wheel unit 100 can be configured to determine the time instant or the time remaining to transmit the transmit signal 102 based on a phase angle estimation. Moreover, the wheel unit 100 can be configured to transmit the transmit signal 102 when the acceleration signal crosses (in a predefined direction) a predefined threshold value, the predefined threshold value corresponding to the predefined rotational position of the wheel 142.

In some embodiments, the wheel unit 100 can comprise a sensor (112 in FIG. 1a) configured to sense a physical property of the wheel 142 or ground 114 under the wheel 142 in order to obtain a sensed information. Thereby, the wheel unit 100 can be configured to transmit the transmit signal 102 comprising the sensed information. For example, the sensor 112 can be a temperature or pressure sensor configured to sense a temperature or pressure of the wheel 142. In addition, the sensor 112 can be configured to sense a physical property of the ground 114 under the wheel 142, such as a condition of the road, e.g., snow, ice or humidity.

Naturally, the central unit 120 can be configured to receive a receive signal 124 comprising the sensed information. In addition, the central unit 120 can be configured to assign the sensed information to the localized wheel 142. For example, if the location of the wheel 142 on the vehicle is front-left 146_2 and the sensed information is a wheel pressure, e.g., 2.1 bar, then the central unit 120 can be configured to assign the wheel pressure, e.g., the 2.1 bar, to the wheel 142 located at front-left 146_2.

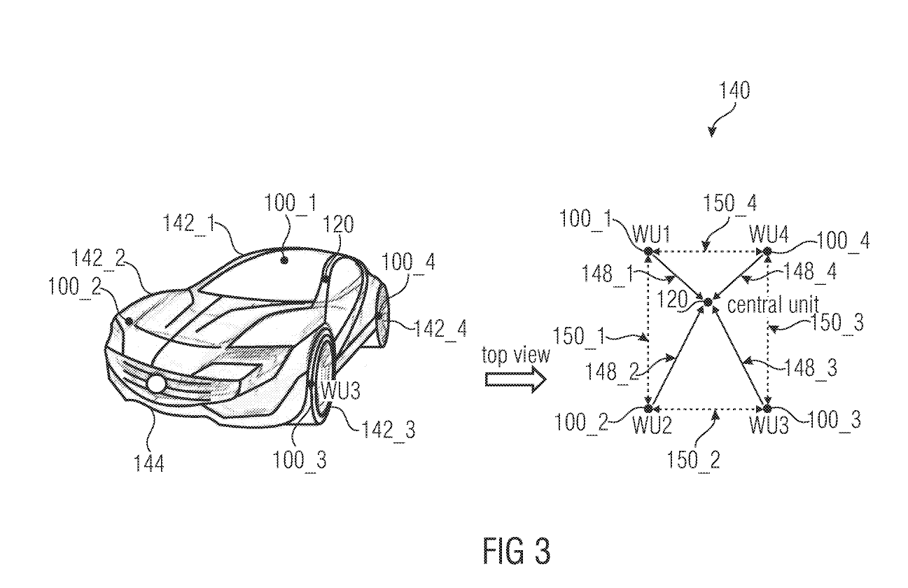

FIG. 3 shows a perspective view and a top view of a vehicle 144 with four wheels 142_1 to 142_4 and a system 140 for localizing a plurality of wheels 142_1 to 142_n (n=4) on the vehicle 144 according to an embodiment of the present invention. The system 140 comprises four wheel units 100_1 to 100_n (n=4) attached to the four wheels 142_1 to 142_4 and a central unit 120. In FIG. 3, the wheels 142_1 and 142_2 are not shown for simplicity reasons.

Note that the vehicle 144 shown in FIG. 3 exemplarily comprises four wheels 142_1 to 142_n (n=4). As already mentioned, the system 140 is also able to locate n wheels 142_1 to 142_n on a vehicle 144, wherein n is a natural number greater than or equal to two (n≧2).

In the following, an embodiment of the system 140 for localizing a plurality of wheels 142_1 to 142_n (n=4) on a vehicle 144 is exemplarily described making reference to FIG. 3. In other words, in the following, a number of wheel units 100_1 to 100_n (n=4), which are equipped with an RF transmitter (104 in FIG. 1a), and a single central unit 120, which is equipped with an RF receiver (126 in FIG. 1a) and is located inside the vehicle 144, is considered. Moreover, the system 140 is able to identify the locations (or positions) of the wheel units 100_1 to 100_n (n=4), e.g. WU3 at front-left, solely based on receive signals 124_1 to 124_n (RF signals).

Asymmetries in the vehicle design lead to different propagation channels 148_1 to 148_n (n=4) between the wheel units 100_1 to 100_n (n=4) (transmitters) and the central unit 120 (receiver). The physical reasons for these differences are distinct multipath properties. Hence, the individual propagation channels 148_1 to 148_n (n=4) act like “fingerprints” for the locations 146_1 to 146_n (n=4) of the wheels 142_1 to 142_n (n=4). According to the concept of the present invention, a spatial small scale fading property of the wireless propagation channels 148_1 to 148_n (n=4) is exploited and the technique of RF signal pattern recognition is employed (location fingerprinting).

The first step of this localization method, which can be performed by the system 140, is to record the receive signal 124_1 to 124_n (n=4) patterns at the central unit 120 from all wheels 142_1 to 142_n (n=4) during a full wheel rotation. Moreover, the receive signal 124_1 to 124_n (n=4) patterns can be stored on the memory 122 of the central unit 120 as the plurality of reference information. The next step is to determine an enhanced or even optimal predefined rotational position of the wheel 142 for localization and data transmission, or in other words, an enhanced or even optimal predefined rotation angle α* of the wheel 142. The selection criterion of the predefined rotation angle α* can be an increased or even best localization performance.

Robustness to error sources such as time variations of the transmit signal 102_1 to 102_n (n=4) patterns and thermal noise is essential for practical implementation of this localization method, which can be performed by the system 140. This can be achieved by a proper design of the transmit signal 102_1 to 102_n (n=4) according to the concept of the present invention. For example, the transmit signal 102_1 to 102_n (n=4) can be a superposition of multiple narrowband signals at sufficiently spaced carrier frequencies (e.g., ISM bands), which provides frequency diversity due to independent fading of the propagation channels 148_1 to 148_n (n=4).

In order to localize a wheel unit 100_1 to 100_n (n=4) with unknown location (or position), the corresponding receive signal 124_1 to 124_n (n=4) pattern is compared to the recorded receive signal 124_1 to 124_n (n=4) patterns and the most likely candidate is selected.

In an alternative embodiment, each wheel unit 100_1 to 100_n (n=4) is equipped with an RF transceiver or with an RF transmitter (104 in FIG. 1a) and an RF receiver (106 in FIG. 1a). Hence, also the propagation channels 150_1 to 150_n (n=4) between the wheel units 100_1 to 100_n (n=4) can be included in the signal patterns. These propagation channels 150_1 to 150_n (n=4) are indicated in FIG. 3 with dashed line arrows. The employment of transceivers can increase the robustness of this localization method, which can be performed by the system 140, even further.

Some embodiments of the present invention provide three core ideas, which have not been proposed up to now in the context of wheel localization and TPMS (TPMS=tire-pressure monitoring systems). The first idea is that the RF transmitters (transceivers) send their (transmit) signals 102_1 to 102_n (n=4) only when their wheel units 100_1 to 100_n (n=4) pass a predetermined and optimal rotation angle α* of the wheel 142_1 to 142_n (n=1), which is the same for all wheels 142_1 to 142_n (n=4). The determination of the predefined rotation angle α* can be based on an increased or even best performance criterion.

In some embodiments, the wheel units 100_1 to 100_n (n=4) do not consume additional power for localization. Furthermore, no additional infrastructure like LF transmitters (L=low frequency) and cabling is required. The only tasks which are on top of data transmission are the determination of an optimal predefined transmission angle α* and the learning of the respective receive signal 124_1 to 124_n (n=4) patterns for the possible locations 146_1 to 146_n (n=4) of the wheels 142_1 to 142_n (n=4) on the vehicle 144.

The second idea is to design the transmit signal 102_1 to 102_n (n=4) such that it provides robustness against error sources like thermal noise or time variations of the signal patterns.

The third idea is to additionally exploit the propagation channels 150_1 to 150_n (n=4) between the wheels 142_1 to 142_n (n=4) for RF signal pattern recognition and, thus, to further increase the robustness. The wheel units 100_1 to 100_4 (n=4) can be equipped with transceivers or receivers (106 in FIG. 1a) in this case.

In the following, an implementation of the localization method, which can be performed by the system 140, according to an embodiment of the present invention is described. Thereby, localization is separated into two phases.

A first phase of the two phases is referred to as training phase. The training phase happens preferably only once in the vehicle 144 factory under human supervision. For each vehicle model the receive signal 124_1 to 124_n (n=4) patterns of all wheel locations 146_1 to 146_n (n=4) are recorded over a full wheel rotation. The choice of the transmission angle α* can be based on an increased or even best performance criterion. For example, if RSS values are used as signal patterns, the transmission angle α* corresponding to the most distinct RSS values can be selected.

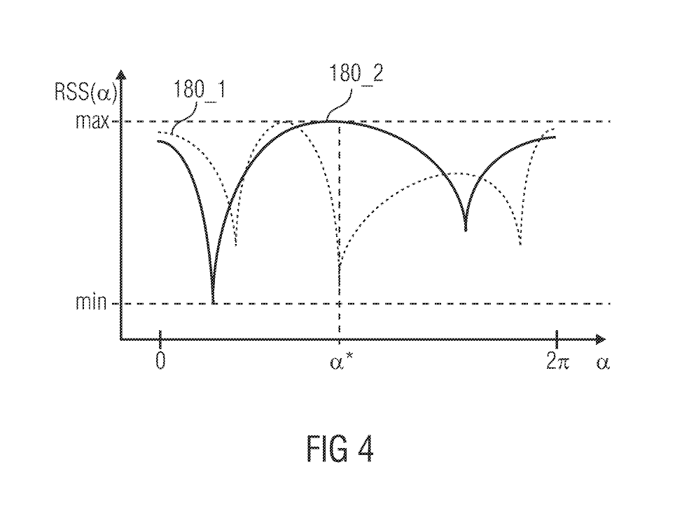

FIG. 4 shows an exemplarily diagram of a first RSS curve 180_1 derived from a first receive signal 124_1 pattern and a second RSS curve 180_2 derived from a second receive signal 124_2 pattern for a full rotation of a first and second wheel 142_1 and 142_2. In other words, FIG. 4 shows two exemplary RSS profiles from two wheels 142_1 and 142_2 over a full wheel rotation. Thereby, the ordinate describes RSS values, where the abscissa describes a rotation angle a of the first and second wheel 142_1 and 142_2. At the angle α* the RSS values of the first and second RSS curves 180_1 and 180_2 have the largest difference, which would make α* the preferred transmission angle. In general, there will be more than two profiles, i.e., more than two wheels.

In some embodiments, changing rims or tires may have (severe) impact on the propagation channels 148_1 to 148_n (n=4), i.e., localization performance. In this case, the training phase might have to be repeated whenever rims or tires are changed. Alternatively, in some embodiments, it is sufficient to train only for certain classes of rims like alloy rim and steel rim. Furthermore, a proper design of the transmit signal 102_1 to 102_n (n=4) can increase the robustness against error caused by changed rims or tires.

A second phase of the two phases is referred to as a localization phase. During the localization phase in normal operation mode a wheel unit 100_1 to 100_n (n=4) transmits its transmit signal 102_1 to 102_n (n=4), e.g., a data packet, at the predefined angle α*. The receiver of the central unit 120 receives the receive signal 124_1 to 124_n (n=4), e.g., the data packet, and derives an information from the receive signal 124_1 to 124_n (n=4), e.g., an RSS value, and compares it to the stored plurality of reference information. The best fit can be chosen as an estimate for the location 146_1 to 146_n (n=4) of the wheel 142_1 to 142_n (n=4). For localization preferably only transmit signals 102_1 to 102_n (n=4), e.g., data packets, are used which would have been sent anyhow, for example, to transmit sensor data. Hence, the only extra cost of localization may be the determination of the predefined transmission angle α*.

In an alternative embodiment, there exists an additional mechanism in the central unit 120, which is responsible for the detection of significant changes of the signal patterns in comparison to the training phase. Such changes may occur due to special road conditions (e.g., snow), interference from other RF sources, and also changed wheels. The consequence of such detected changes might be either a rejection of the corresponding signal patterns followed by another localization try with new signal patterns or the initialization of a new training phase.

Moreover, the central unit 120 can be configured to detect a difference between the plurality of reference information and the information derived from the receive signal (124_1 to 124_n (n=4)) during the comparison between the plurality of reference information and the information derived from the receive signal (124_1 to 124_n (n=4)). Thereby, the information derived from the receive signal (124_1 to 124_n (n=4)) may be discarded if the difference exceeds a predefined difference.

For example, the plurality of reference information stored on the memory 122 of the central unit 120 can be RSS reference values, where the information derived from the receive signal (124_1 to 124_n (n=4)) can be an RSS value. In that case, the central unit 120 can be configured to detect the difference between the RSS reference values and the RSS value derived from receive signal (124_1 to 124_n (n=4)), where the RSS value derived from receive signal (124_1 to 124_n (n=4)) is discarded if the detected difference exceeds a predefined difference. The predefined difference can be a predefined difference value such as ±5 dB, ±10 dB or ±15 dB.

Furthermore, the central unit 120 can be configured to detect a number of discarded information (e.g. RSS values) during a predefined time interval, where the system 140 can be configured to initialize or reinitialize the training phase if the number of discarded information is greater than a predefined number.

For example, the central unit 120 can be configured to reinitialize the training phase if the number of discarded information during the predefined time interval (e.g. 30 s, 240 s, 10 min or 30 min) is greater than a predefined number such as 10, 20 or 100.

Moreover, in some embodiments, any existing wheel localization method, which does not require additional hardware, may be used to adapt to significant and permanent changes of the signal patterns (e.g., changed wheels). Moreover, if the wheel units 102_1 to 102_n (n=4) comprise RF receivers (106 in FIG. 1a), the training phase can be initiated by the control unit 120, for example, by transmitting a training phase initialization command to the wheel units 100_1 to 100_n (n=4). For example, during the training phase a localization method can be used that relies on the fact that different tires have slightly different diameters, i.e., different angular speeds, due to pressure, temperature, load distribution, etc. The angular speeds (travel distances, diameters) of all wheels are once measured in the wheel units 100_1 to 100_n (n=4) and once measured with fixed installed sensors near the wheels 142_1 to 142_n (n=4), such as ABS sensors (ABS=antilock braking system). Comparing these values enables localization of the wheel units 100_1 to 100_n (n=4).

Nevertheless, the system 140 will have more complexity and consume more power in this phase. However, this phase is executed only when significant changes of the signal patterns are detected, which happens very seldom. As soon as the signal patterns are adapted, the system 140 switches back to the low complexity and low power localization phase according to the concept of the present invention described above.

In an alternative embodiment, multiple transmission angles, e.g., α* and α**, are used to obtain spatial diversity and increase robustness.

In another alternative embodiment, ultra-short pulses in the order of sub-nanoseconds are used as transmit signals 102_1 to 102_n (n=4). Such ultra-wideband signals have a very large bandwidth and, hence, a very high degree of frequency diversity.

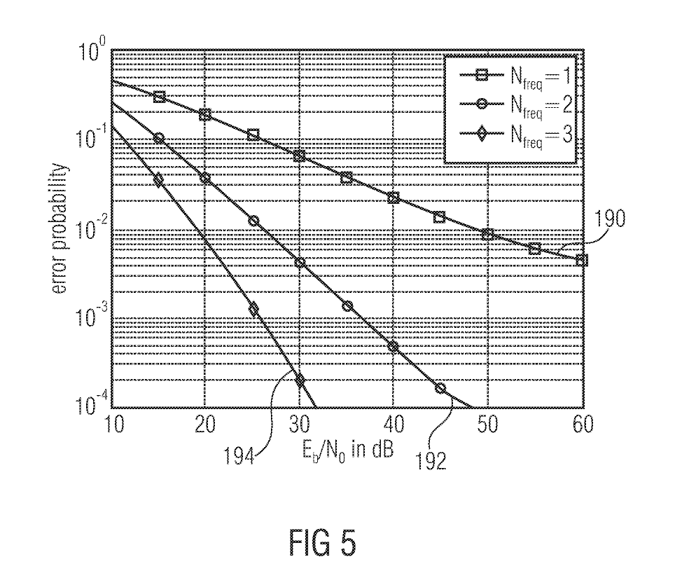

FIG. 5 shows a diagram of an average probability of a localization error as a function of the signal-to-noise ratio when the information derived from the receive signal is an RSS value. In other words, FIG. 5 depicts an average probability of a localization error as a function of the signal-to-noise-ratio (energy per bit over noise power spectral density) when RSS values form the signal pattern. A first curve 190 with square markers depicts the performance when only a single frequency band and a single transmission angle are used, which leads to a single RSS value as signal pattern. A second curve 192 with circle markers is obtained when an additional frequency band or an additional transmission angle are used, which results in two RSS values as signal pattern. A third curve 194 with diamond markers is obtained by using three RSS values. As shown in FIG. 5, the SNR, which is required to achieve less than one percent error rate, can be reduced from 50 dB to 20 dB when three RSS values are used as signal pattern.

Further embodiments of the present invention provide a system 140 for localizing a plurality of wheels 142_1 to 142_n on a vehicle 144 that is able to reduce or even minimize power consumption and infrastructure costs required for localization

In addition, embodiments of the present invention provide a localization method, that can be performed by the system 140 for localizing a plurality of wheels 142_1 to 142_n on a vehicle 144, and that is robust against error sources.

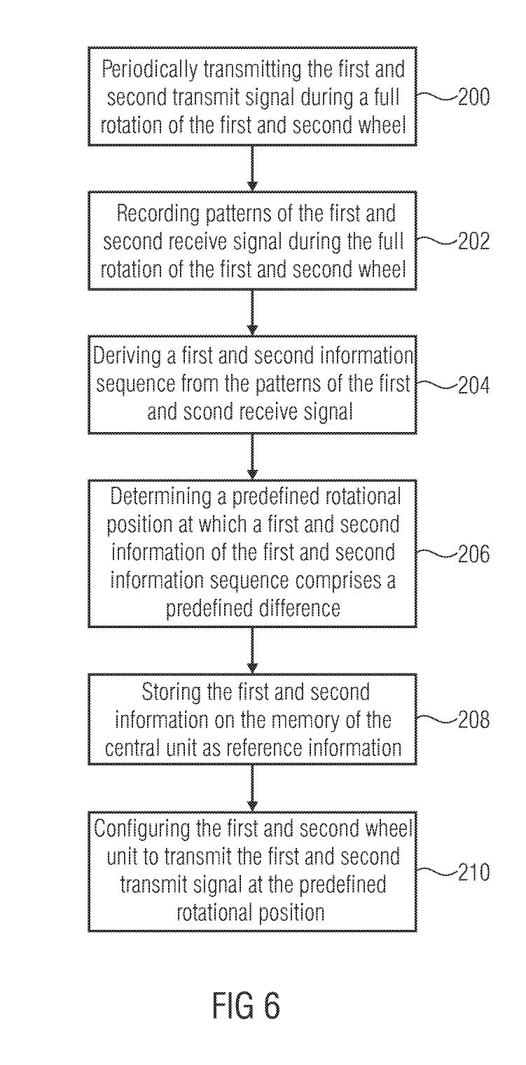

FIG. 6 shows a flowchart of a method for providing a plurality of reference information for a system for localizing a plurality of wheels on a vehicle as already described in detail above. In a first step 200, the first transmit signal is transmitted periodically (or, alternatively, continuously) by the first wheel unit during a full rotation of the first wheel and the second transmit signal is transmitted continuously or periodically by the second wheel unit during a full rotation of the second wheel. In a second step 202, recording a pattern of the first receive signal during the full rotation of the first wheel and recording a pattern of the second receive signal during the full rotation of the second wheel. In a third step 204, a first information sequence is derived from the pattern of the first receive signal and a second information sequence is derived from the pattern of the second receive signal. In a fourth step 206, a predefined rotational position of the first and second wheel is determined at which a first information of the first information sequence and a second information of the second information sequence comprise a difference that provides an average correct localization probability of the plurality of wheels on the vehicle of at least 60%, 70%, 75% or 90%. In a fifth step 208, the first information and the second information is stored on the memory of the central unit as reference information. In a sixth step 210, configuring the first and second wheel unit to transmit the first and second transmit signal at the predefined rotational position of the first and second wheel.

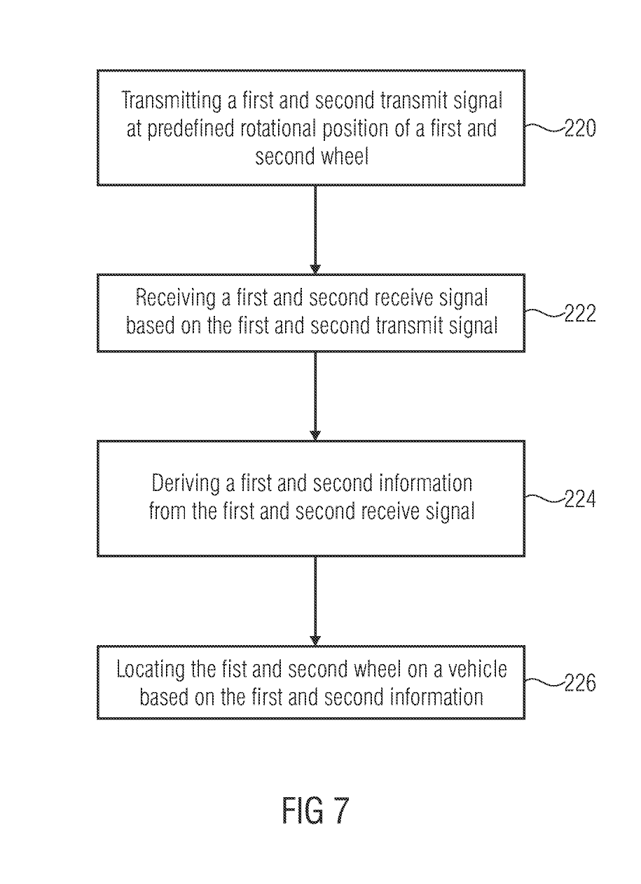

FIG. 7 shows a flowchart of a method for localizing a plurality of wheels on a vehicle. In a first step 220, a first transmit signal is transmitted at a predefined rotational position of a first wheel of the plurality of wheels by a first wheel unit attached to the first wheel, and a second transmit signal is transmitted at the predefined rotational position of a second wheel of the plurality of wheels by a second wheel unit attached to the second wheel. In a second step 222, a first receive signal is received by a central unit based on the first transmit signal transmitted by the first wheel unit over a communication channel between the first wheel unit and the central unit, and a second receive signal is received by the central unit based on the second transmit signal transmitted by the second wheel unit over a communication channel between the second wheel unit and the central unit. In a third step 224, a first information is derived from the first receive signal and a second information is derived from the second receive signal. In a fourth step 226, the first wheel on the vehicle is localized based on a comparison between a plurality of reference information and the first information, and the second wheel on the vehicle is localized based on a comparison between the plurality of reference information and the second information, the plurality of reference information corresponding to locations of the plurality of wheels on the vehicle.

In some embodiments, in the first step 220, a first additional transmit signal can be transmitted at an additional predefined rotational position of the first wheel by the first wheel unit, and a second additional transmit signal can be transmitted at the additional predefined rotational position of the second wheel by the second wheel unit. In the second step 222, a first additional receive signal can be received with the central unit based on the first additional transmit signal transmitted by the first wheel unit at the additional predefined rotational position of the first wheel, and a second additional receive signal can be received with the central unit based on the second additional transmit signal transmitted by the second wheel unit at the additional predefined rotational position of the second wheel. In the third step 224, a first additional information can be derived from the first additional receive signal, and a second additional information can be derived from the second additional receive signal. In the fourth step 226, the first wheel on the vehicle can be localized further based on a comparison between a plurality of additional reference information and the first additional information, and the second wheel on the vehicle can be localized further based on a comparison between the plurality of additional reference information and the second additional information, the plurality of additional reference information corresponding to the locations of the plurality of wheels on the vehicle.

Moreover, in the first step 220, the first transmit signal can be transmitted by an RF transmitter of the first wheel unit, and the second transmit signal can be transmitted by an RF transmitter of the second wheel unit, wherein the first and second transmit signals comprise at least two frequencies located in different frequency bands. In the second step 222, the first and second receive signals can be received by an RF receiver of the central unit, wherein the first and second receive signals comprise the at least two frequencies located in the different frequency bands.

In addition, a receive signal can be received with the first wheel unit based on the second transmit signal transmitted by the second wheel unit over a communication channel between the second wheel unit and the first wheel unit, and a receive signal can be received with the second wheel unit based on the first transmit signal transmitted by the first wheel unit over a communication channel between the first wheel unit and the second wheel unit. In that case, the first transmit signal can be transmitted comprising a first attached information based on the receive signal received from the second wheel unit, and the second transmit signal can be transmitted comprising a second attached information based on the first receive signal received from the first wheel unit. Thereby, the first receive signal and the second receive signal can be received, wherein the first receive signal comprises the second attached information and the second receive signal comprises the first attached information. Furthermore, the first and second wheel on the vehicle can be localized further based on the first and second attached information.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like, for example, a microprocessor, a programmable computer or an electronic circuit. In some embodiments, some one or more of the most important method steps may be executed by such an apparatus.

Depending on certain implementation requirements, embodiments of the invention can be implemented in hardware or in software. The implementation can be performed using a digital storage medium, for example, a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment comprises a processing means, for example, a computer, or a programmable logic device, configured to or adapted to perform one of the methods described herein.

A further embodiment comprises a computer having installed thereon the computer program for performing one of the methods described herein.

In some embodiments, a programmable logic device (for example, a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

The above described embodiments are merely illustrative for the principles of the present invention. It is understood that modifications and variations of the arrangements and the details described herein will be apparent to others skilled in the art. It is the intent, therefore, to be limited only by the scope of the pending patent claims and not by the specific details presented by way of description and explanation of the embodiments herein.

What is claimed is:

1. A wheel unit configured to transmit a transmit signal at a predefined rotational position of a wheel rotating around a rotational axis, when the wheel unit is attached to the wheel.

2. The wheel unit according to claim 1, wherein the wheel unit is configured to transmit an additional transmit signal at an additional predefined rotational position of the wheel.

3. The wheel unit according to claim 1, wherein the wheel unit comprises an RF transmitter configured to transmit the transmit signal comprising at least two frequencies located in different frequency bands.

4. The wheel unit according to claim 3, wherein the transmit signal comprises at least two frequencies located in different ISM bands.

5. The wheel unit according to claim 1, wherein the wheel unit comprises an RF receiver configured to receive a receive signal based on a transmit signal transmitted by a further wheel unit over a communication channel between the further wheel unit and the wheel unit at a predefined rotational position of a further wheel, the further wheel unit is attached to, and wherein the wheel unit is configured to transmit the transmit signal comprising an attached information based on the receive signal received from the further wheel unit.

6. The wheel unit according to claim 1, wherein the wheel unit comprises an acceleration sensor configured to provide an acceleration signal, wherein the wheel unit is configured to transmit the transmit signal at the predefined rotational position of the wheel based on the acceleration signal.

7. The wheel unit according to claim 1, wherein the wheel unit comprises a sensor configured to sense a physical property of the wheel in order to obtain a sensed information, and wherein the wheel unit is configured to transmit the transmit signal comprising the sensed information of the wheel.

8. A central unit for localizing a wheel on a vehicle, wherein the central unit comprises a memory having stored thereon a plurality of reference information, the plurality of reference information corresponding to locations of the wheel on the vehicle;
wherein the central unit is configured to receive a receive signal based on a transmit signal transmitted by a wheel unit over a communication channel between the wheel unit and the central unit at a predefined rotational position of the wheel that the wheel unit is attached to; and
wherein the central unit is configured to derive an information from the receive signal and to localize the wheel on the vehicle based on a comparison between the plurality of reference information and the information.

9. The central unit according to claim 8, wherein a plurality of additional reference information is stored on the memory of the central unit, the plurality of additional reference information corresponding to the locations of a plurality of wheels on the vehicle;
wherein the central unit is configured to receive an additional receive signal based on an additional transmit signal transmitted by the wheel unit at an additional predefined rotational position of the wheel; and
wherein the central unit is further configured to derive an additional information from the additional receive signal and to localize the wheel on the vehicle further based on a comparison between the plurality of additional reference information and the additional information.

10. The central unit according to claim 8, wherein the central unit comprises an RF receiver configured to receive the receive signal comprising at least two frequencies located at different frequency bands.

11. The central unit according to claim 10, wherein the receive signal comprises at least two frequencies located at different ISM bands.

12. The central unit according to claim 8, wherein the receive signal comprises an attached information based on a receive signal received by the wheel unit based on a transmit signal transmitted by a further wheel unit over a communication channel between the further wheel unit and the wheel unit at a predefined rotational position of a further wheel, the further wheel unit is attached to, and wherein the central unit is configured to localize the wheel on the vehicle further based on the attached information.

13. The central unit according to claim 8, wherein the receive signal comprises a sensed information describing a sensed physical property of the wheel, wherein the central unit is configured to derive the sensed information from the receive signal and to assign the sensed information to the localized wheel.

14. The central unit according to claim 8, wherein the plurality of reference information stored on the memory are RSS values corresponding to the locations of the wheel on the vehicle.

15. A system for localizing a plurality of wheels on a vehicle, the system comprising:
a central unit with a memory having stored thereon a plurality of reference information, the plurality of reference information corresponding to locations of the plurality of wheels on the vehicle;
a first wheel unit attached to a first wheel of the plurality of wheels and a second wheel unit attached to a second wheel of the plurality of wheels, wherein the first wheel unit is configured to transmit a first transmit signal at a predefined rotational position of the first wheel, and wherein the second wheel unit is configured to transmit a second transmit signal at a predefined rotational position of the second wheel;
wherein the central unit is configured to receive a first receive signal based on the first transmit signal transmitted by the first wheel unit over a communication channel between the first wheel unit and the central unit, and to receive a second receive signal based on the second transmit signal transmitted by the second wheel unit over a communication channel between the second wheel unit and the central unit; and
wherein the central unit is further configured to derive a first information from the first receive signal and a second information from the second receive signal, and to localize the first wheel on the vehicle based on a comparison between the plurality of reference information and the first information, and to localize the second wheel on the vehicle based on a comparison between the plurality of reference information and the second information.

16. The system according to claim 15, further comprising:
a third wheel unit attached to a third wheel of the plurality of wheels and a fourth wheel unit attached to a fourth wheel of the plurality of wheels, wherein the third wheel unit is configured to transmit a third transmit signal at a predefined rotational position of the third wheel, and wherein the fourth wheel unit is configured to transmit a fourth transmit signal at a predefined rotational position of the fourth wheel;
wherein the central unit is configured to receive a third signal based on the third transmit signal transmitted by the third wheel unit over a communication channel between the third wheel unit and the central unit, and to receive a fourth receive signal based on the fourth transmit signal transmitted by the fourth wheel unit over a communication channel between the fourth wheel unit and the central unit; and
wherein the central unit is further configured to derive a third information from the third receive signal and a fourth information from the fourth receive signal, and to localize the third wheel on the vehicle based on a comparison between the plurality of reference information and the third information, and to localize the fourth wheel on the vehicle based on a comparison between the plurality of reference information and the fourth information.

17. The system according to claim 15, wherein a plurality of additional reference information is stored on the memory of the central unit, the plurality of additional reference information corresponding to the locations of the plurality of wheels on the vehicle;
wherein the first wheel unit is configured to transmit a first additional transmit signal at an additional predefined rotational position of the first wheel, and wherein the second wheel unit is configured to transmit a second additional transmit signal at the additional predefined rotational position of the second wheel;
wherein the central unit is configured to receive a first additional receive signal based on the first additional transmit signal transmitted by the first wheel unit at the additional predefined rotational position, and to receive a second additional receive signal based on the second additional transmit signal transmitted by the second wheel unit at the additional predefined rotational position; and
wherein the central unit is further configured to derive a first additional information from the first additional receive signal and a second additional information from the second additional receive signal, and to localize the first wheel on the vehicle further based on a comparison between the plurality of additional reference information and the first additional information, and to localize the second wheel on the vehicle further based on a comparison between the plurality of additional reference information and the second additional information.

18. The system according to claim 15, wherein the first wheel unit comprises an RF transmitter configured to transmit the first transmit signal and the second wheel unit comprises an RF transmitter configured to transmit the second transmit signal, wherein the first and second transmit signals comprise at least two frequencies located in different frequency bands; and
wherein the central unit comprises an RF receiver configured to receive the first and second receive signal, wherein the first and second receive signals comprise the at least two frequencies located in the different frequency bands.

19. The system according to claim 15, wherein the first wheel unit comprises an RF receiver configured to receive a receive signal based on the second transmit signal transmitted by the second wheel unit over a communication channel between the second wheel unit and the first wheel unit, wherein the second wheel unit comprises an RF receiver configured to receive a receive signal based on the first transmit signal transmitted by the first wheel unit over a communication channel between the first wheel unit and the second wheel unit;
wherein the first wheel unit is configured to transmit the first transmit signal comprising a first attached information based on the receive signal received from the second wheel unit, wherein the second wheel unit is configured to transmit the second transmit signal comprising a second attached information based on the receive signal received from the first wheel unit;
wherein the central unit is configured to receive the first receive signal and the second receive signal, wherein the first receive signal comprises the second attached information, and wherein the second receive signal comprises the first attached information; and
wherein the central unit is further configured to localize the first and second wheel on the vehicle based on the first and second attached information.

20. The system according to claim 15, wherein the first wheel unit comprises a sensor configured to sense a physical property of the first wheel in order to obtain a first sensed information, and wherein the second wheel unit comprises a sensor configured to sense a physical property of the second wheel in order to obtain a second sensed information; and
wherein the first wheel unit is configured to transit the first transmit signal comprising the first sensed information, and wherein the second wheel unit is configured to transmit the second transmit signal comprising the second sensed information.

21. The system according to claim 20, wherein the central unit is further configured to derive the first sensed information from the first receive signal and the second sensed information from the second receive signal, and to assign the first sensed information to the localized first wheel and the second sensed information to the localized second wheel.

22. A method for providing a plurality of reference information for a system for localizing a plurality of wheels on a vehicle, the system comprising a first wheel unit attached to a first wheel of the plurality of wheels and configured to transmit a first transmit signal, a second wheel unit attached to a second wheel of the plurality of wheels and configured to transmit a second transmit signal, and a central unit with a memory for storing a plurality of reference information, the plurality of reference information corresponding to locations of the plurality of wheels on the vehicle, wherein the central unit is configured to receive a first receive signal based on the first transmit signal transmitted by the first wheel unit over a communication channel between the first wheel unit and the central unit, and to receive a second receive signal based on the second transmit signal transmitted by the second wheel unit over a communication channel between the second wheel unit and the central unit, the method comprising:
continuously transmitting the first transmit signal by the first wheel unit during a full rotation of the first wheel and continuously transmitting the second transmit signal by the second wheel unit during a full rotation of the second wheel;
recording a pattern of the first receive signal during the full rotation of the first wheel and recording a pattern of the second receive signal during the full rotation of the second wheel;
deriving a first information sequence from the pattern of the first receive signal and deriving a second information sequence from the pattern of the second receive signal;
determining a predefined rotational position of the first and second wheel at which a first information of the first information sequence and a second information of the second information sequence comprise a difference that provides an average correct localization probability of the plurality of wheels on the vehicle of at least 60%;
storing the first information and the second information on the memory of the central unit as reference information; and
configuring the first and second wheel unit to transmit the first and second transmit signal at the predefined rotational position of the first and second wheel.

23. A method for localizing a plurality of wheels on a vehicle, the method comprising:
transmitting a first transmit signal at a predefined rotational position of a first wheel of the plurality of wheels by a first wheel unit attached to the first wheel, and transmitting a second transmit signal at a predefined rotational position of a second wheel of the plurality of wheels by a second wheel unit attached to the second wheel;
receiving a first receive signal with a central unit based on the first transmit signal transmitted by the first wheel unit over a communication channel between the first wheel unit and the central unit, and receiving a second receive signal with the central unit based on the second transmit signal transmitted by the second wheel unit over a communication channel between the second wheel unit and the central unit;
deriving a first information from the first receive signal and deriving a second information from the second receive signal;
localizing the first wheel on the vehicle based on a comparison between a plurality of reference information and the first information, and localizing the second wheel on the vehicle based on a comparison between the plurality of reference information and the second information, the plurality of reference information corresponding to locations of the plurality of wheels on the vehicle.

24. The method according to claim 23, comprising:
transmitting a first additional transmit signal at an additional predefined rotational position of the first wheel by the first wheel unit, and transmitting a second additional transmit signal at an additional predefined rotational position of the second wheel by the second wheel unit;
receiving a first additional receive signal with the central unit based on the first additional transmit signal transmitted by the first wheel unit at the additional predefined rotational position of the first wheel, and receiving a second additional receive signal with the central unit based on the second additional transmit signal transmitted by the second wheel unit at the additional predefined rotational position of the second wheel;
deriving a first additional information from the first additional receive signal, and deriving a second additional information from the second additional receive signal; and
localizing the first wheel on the vehicle further based on a comparison between a plurality of additional reference information and the first additional information, and localizing the second wheel on the vehicle further based on a comparison between the plurality of additional reference information and the second additional information, the plurality of additional reference information corresponding to the locations of the plurality of wheels on the vehicle.

25. The method according to claim 23, wherein the first transmit signal is transmitted by an RF transmitter of the first wheel unit, and wherein the second transmit signal is transmitted by an RF transmitter of the second wheel unit, wherein the first and second transmit signals comprise at least two frequencies located in different frequency bands; and
wherein the first and second receive signals are received by an RF receiver of the central unit, wherein the first and second receive signals comprise the at least two frequencies located in the different frequency bands.

26. The method according to claim 23, comprising:
receiving a receive signal with the first wheel unit based on the second transmit signal transmitted by the second wheel unit over a communication channel between the second wheel unit and the first wheel unit, and receiving a receive signal with the second wheel unit based on the first transmit signal transmitted by the first wheel unit over a communication channel between the first wheel unit and the second wheel unit;
transmitting the first transmit signal comprising a first attached information based on the receive signal received from the second wheel unit, and transmitting the second transmit signal comprising a second attached information based on the first receive signal received from the first wheel unit;
receiving the first receive signal and the second receive signal, wherein the first receive signal comprises the second attached information and the second receive signal comprises the first attached information; and
localizing the first and second wheel on the vehicle further based on the first and second attached information.

27. The method according to claim 23, comprising:
detecting a first difference between the plurality of reference information and the first information during the comparison between the plurality of reference information and the first information, and detecting a second difference between the plurality of reference information and the first information during the comparison between the plurality of reference information and the second information; and
discarding the first information if the first difference exceeds a predefined difference, and discarding the second information if the second difference exceeds the predefined difference.

28. The method according to claim 27, comprising:
detecting a first number of discarded first information during a predefined time interval and detecting a second number of discarded second information during the predefined time interval;
performing a method for providing a plurality of reference information if the first number or the second number is greater than a predefined number, the method for providing the plurality of updated reference information comprising:
continuously transmitting the first transmit signal by the first wheel unit during a full rotation of the first wheel and continuously transmitting the second transmit signal by the second wheel unit during a full rotation of the second wheel;
recording a pattern of the first receive signal during the full rotation of the first wheel and recording a pattern of the second receive signal during the full rotation of the second wheel;
deriving a first information sequence from the pattern of the first receive signal and deriving a second information sequence from the pattern of the second receive signal;
determining a predefined rotational position of the first and second wheel at which a first information of the first information sequence and a second information of the second information sequence comprise a difference that provides an average correct localization probability of the plurality of wheels on the vehicle of at least 60%;
storing the first information and the second information on the memory of the central unit as reference information; and
configuring the first and second wheel unit to transmit the first and second transmit signal at the predefined rotational position of the first and second wheel.

29. A computer readable digital storage medium having stored thereon a computer program having a program code for performing, when running on a computer, a method for localizing a plurality of wheels on a vehicle, the method comprising:
transmitting a first transmit signal at a predefined rotational position of a first wheel of the plurality of wheels by a first wheel unit attached to the first wheel, and transmitting a second transmit signal at a predefined rotational position of a second wheel of the plurality of wheels by a second wheel unit attached to the second wheel;
receiving a first receive signal with a central unit based on the first transmit signal transmitted by the first wheel unit over a communication channel between the first wheel unit and the central unit, and receiving a second receive signal with the central unit based on the second transmit signal transmitted by the second wheel unit over a communication channel between the second wheel unit and the central unit;
deriving a first information from the first receive signal and deriving a second information from the second receive signal;
localizing the first wheel on the vehicle based on a comparison between a plurality of reference information and the first information, and localizing the second wheel on the vehicle based on a comparison between the plurality of reference information and the second information, the plurality of reference information corresponding to locations of the plurality of wheels on the vehicle.
